(19) United States
(12) Patent Application Publication
(10) Pub. No.: US 2017/0197573 A1
(43) Pub. Date: Jul. 13, 2017

(54) Deployable and Smart Car Bumper

(71) Applicant: Jahangir S. Rastegar, Stony Brook, NY (US)

(72) Inventor: Jahangir S. Rastegar, Stony Brook, NY (US)

(73) Assignee: Omnitek Partners LLC, Ronkonkoma, NY (US)

(21) Appl. No.: 14/991,973

(22) Filed: Jan. 10, 2016

(51) Int. Cl. B60R 19/48; B60R 19/04; B60R 19/02

(52) U.S. Cl. CPC B60R 19/483; B60R 19/023; B60R 19/04

(57) ABSTRACT

A method for protecting an automobile, the method including: detecting one or more conditions indicative of an impending collision; and deploying one or more bumpers on the automobile for absorbing at least some energy of the collision.

### BACKGROUND OF THE INVENTION

1. Field of the Invention

The present invention relates generally to vehicle bumpers, and more particularly to vehicle bumpers that are deployable when collision with an object is detected by the vehicle sensors to significantly increase the range of bumper deformation upon impact, thereby significantly reduce impact induced impulsive forces and energy absorption.

2. Prior Art

Bumpers are used on motor vehicles to absorb low level impact forces and to limit the amount of damage sustained to the vehicle body during high level impacts. To increase the effectiveness of bumper systems in vehicles in terms of reducing impact induced forces and impact energy absorption, the size in the outward direction (outward projection) of the bumper has to be increased to reduce the level of impact induced impulsive forces by spreading the force over longer durations, i.e., to allow for larger deformation of the bumper in the direction of the applied impact force. In an attempt to achieve this objective, many of the known bumper systems have necessarily resulted in arrangements involving an undesirably large size or space requirement.

Conventional design practice is to provide a bumper system having a single simple beam which, when impacted, absorbs energy by permitting plastic deformation. This arrangement of the simple beam, however, provides an inefficient energy absorbing capability, and hence the bumper system is conventionally provided with separate energy absorbers such as struts, springs or foam members which cooperate with the beam. To ensure that such conventional designs provide large enough deformation capability in the direction of impact, usually along the length of the vehicle, the bumper system would require a significant space and would have to protrude significantly outwards (from the front and rear of the vehicle). As a result, the extended bumpers would increase the total length of the vehicle a significant amount, which is highly undesirable. In addition, such extended bumpers would also damage the appearance of the vehicle.

A need therefore exists for bumpers for the front and/or rear of vehicles that normally extend nearly the same as currently used bumpers, but upon vehicle sensing of collision with an object would deploy further outward together with its shock absorbing and energy dissipating components to significantly increase the bumper range of deformation and/or travel with the goal of achieving a significant reduction in the peak impact force levels and a significant increase in the bumper system impact energy absorption.

### SUMMARY OF THE INVENTION

One object of the present invention is to provide the methods to design deployable bumpers for front and/or rear of vehicles that are developed when the vehicle sensors detect objects with which the vehicle is about to collide and the means and apparatus for their design and a number of preferred such deployable bumper design embodiments for vehicles.

Many current vehicles already have sensory devices for detecting objects in front, back and sometimes on the side of a vehicle and alert the driver or automatically take appropriate evasive or braking actions. Such sensors are mostly based on Radio Frequency (RF), Radar, or optical (laser) or camera or a combination of thereof. Such sensors that can detect object in collision course with the vehicle in front and rear as well as the sides of a vehicle are well known in the art. It is also expected that most vehicles will be equipped with such sensors in near future. Such sensors can provide information as to the distance, velocity and when desired, the acceleration of the vehicle relative to the said objects in near real time. In addition, since the vehicle velocity is known at all times to the commonly used vehicle microprocessor (computer) based control unit, the said control unit can also determine the velocity and acceleration of the object if it is also in motion. The said sensor provided distance, velocity and/or acceleration information is used for the operation of the different deployable bumper system embodiments of the present invention.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic of the first embodiment of a deployable bumper for vehicles and the like.

FIG. 2 illustrates a schematic of the second embodiment of a deployable bumper for vehicles and the like constructed with multiple deployable segments.

FIG. 3 illustrates the frontal view of a deployable bumper embodiment for vehicles and the like constructed with multiple stacked deployable segments.

FIG. 4 illustrates the frontal view of another embodiment of a deployable bumper for vehicles and the like with multiple deployable segments that are mounted inside the main bumper body.

### DETAILED DESCRIPTION OF THE PREFERRED EMBODIMENT

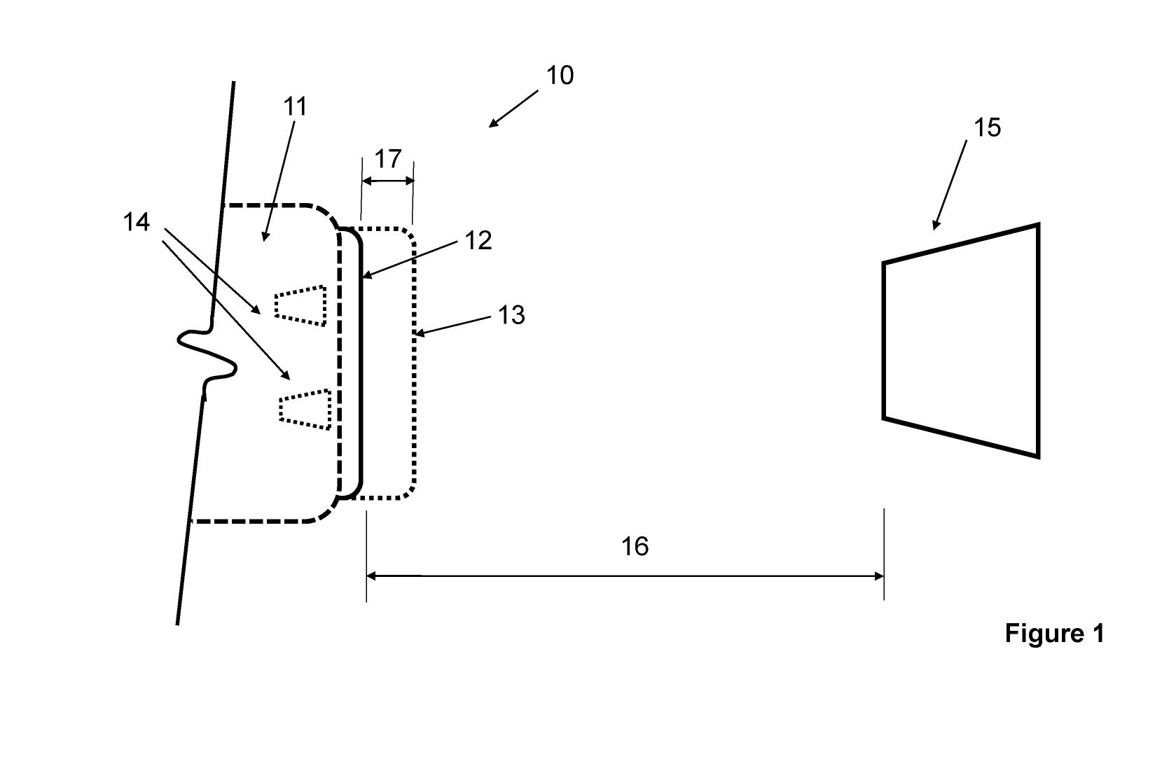

A schematic of the first embodiment is shown in FIG. 1. In FIG. 1, the frontal (or rear) section 11 of a vehicle is shown which is equipped with the deployable bumper 12, shown in its pre-deployment position with solid lines. The vehicle is considered to be equipped with a sensory system (not shown but consisting of appropriate electronics depending on the type of sensor being used and preferably equipped with one or more microprocessor to perform velocity and acceleration and other related calculations) with at least one sensor 14, which can detect the distance between the (un-deployed) bumper 12 and any stationary or moving object 15 in the path of motion of the bumper. Such sensors are well known in the art, such as sonar sensors which bounce a sound wave off of an object in the sensors path and measures any signal returning to the sensor and the time it takes to receive the return signal. RF based sensors or laser sensors can also be used.

Then when the sensors 14 of the sensory system detects the object 15 and it is at a relative distance 16 between the bumper and the facing surface of the object, and preferably after determining the relative velocity and preferably acceleration, i.e., the rate with which the distance 16 is decreasing (relative velocity) and the rate of change of the said relative velocity (relative acceleration), then the bumper deployment control unit (not shown and to be described later in this disclosure) will deploy the bumper 12 forward a distance 17 as shown by dashed line in FIG. 1 and indicated by the numeral 13, i.e., extend it away a distance 17 from the vehicle and towards the surface of the incoming object 15. Thereby providing an increased distance for displacement (and possibly deformation) of the bumper 12 from its deployed position 13 before causing damage to the vehicle. In addition, the increased bumper travel allows the provision of appropriate shock absorbing and peak impact force reduction materials and components commonly used in the art and/or those to be described later in this disclosure.

In addition, if the at least one sensor 14 and its related sensory system are provided with the means to measure the aforementioned relative velocity and preferably acceleration or is provided with algorithms to calculate the relative velocity and acceleration, then the information can be used by the bumper deployment control unit to plan an optimal strategy for its deployment. Sensors for measuring relative velocity and acceleration are also well known in the art. When the bumper deployment system control unit is equipped with the means of varying the rate of deployment profile and possibly the means of varying its stiffness and energy absorption and dissipation characteristics (i.e., stiffness and viscous and dry damping or braking and the like characteristics), then the bumper deployment control unit can use the input relative distance, velocity and preferably acceleration to plan an optimal deployment “trajectory” to minimize damage to vehicle and/or shock loading to the passengers, and possibly to the impacting object. For the case of vehicular collision, the sensors 14 alone or together with other sensors such as camera with a data base can also be used to identify the object vehicle type and provide an estimate of its weight and also facing bumper or side characteristics for the bumper deployment control unit planning of its said bumper deployment strategy.

The sensors 14 may also be used to determine (exactly or approximately estimate) the location of the impact on the bumper and use the information for the bumper deployment control unit for bumper (unitary, segmented, etc.) optimal deployment strategy. This information can be generated as a function of time before and during the collision process to provide information about the relative position and orientation of the vehicle and bumper and if segments (if any), etc., for optimal deployment for impact shock and energy absorption management and minimization of injury to the passengers and damage to the vehicle.

In one embodiment, the bumpers on vehicles or the vehicle itself broadcast information as to the type of vehicle, whether front or rear, and other characteristics such as weight of the vehicle, the type and size and positioning of the bumper, their deployment state, etc. The information is preferably broadcast by the bumper sensors, particularly if the sensors are RF or laser based by modulating information on their signals. Then if both colliding bumpers have the said information, they could coordinate their deployment to minimize damage and impact shock, etc., to both vehicles. The information may be similarly used when a bumper is colliding other sides of the vehicle.

The bumper sensors may be used directly, particularly if they are radar or laser or vision based, or via other sensors mounted on the vehicle such as cameras, to estimate to estimate the size, weight, location of the bumper, its orientation and possibly the type of approaching vehicle for planning an optimal bumper deployment strategy.

The said sensor may be configured to continuously provide distance measurement between the bumper and the object on its path of travel or the distance information may be provided at discrete time intervals. The sensor may also be configured to provide the distance information at certain time intervals until a collision possibility is detected and then either increase the rate of distance measurements or begin to provide a continuous stream of distance measurement(s). The rate at which the distance information is provided to the deployable bumper control unit and must however be high, i.e., the sampling time must be small enough, so that the aforementioned relative velocities and accelerations could be accurately be determined for effective bumper deployment and control purposes.

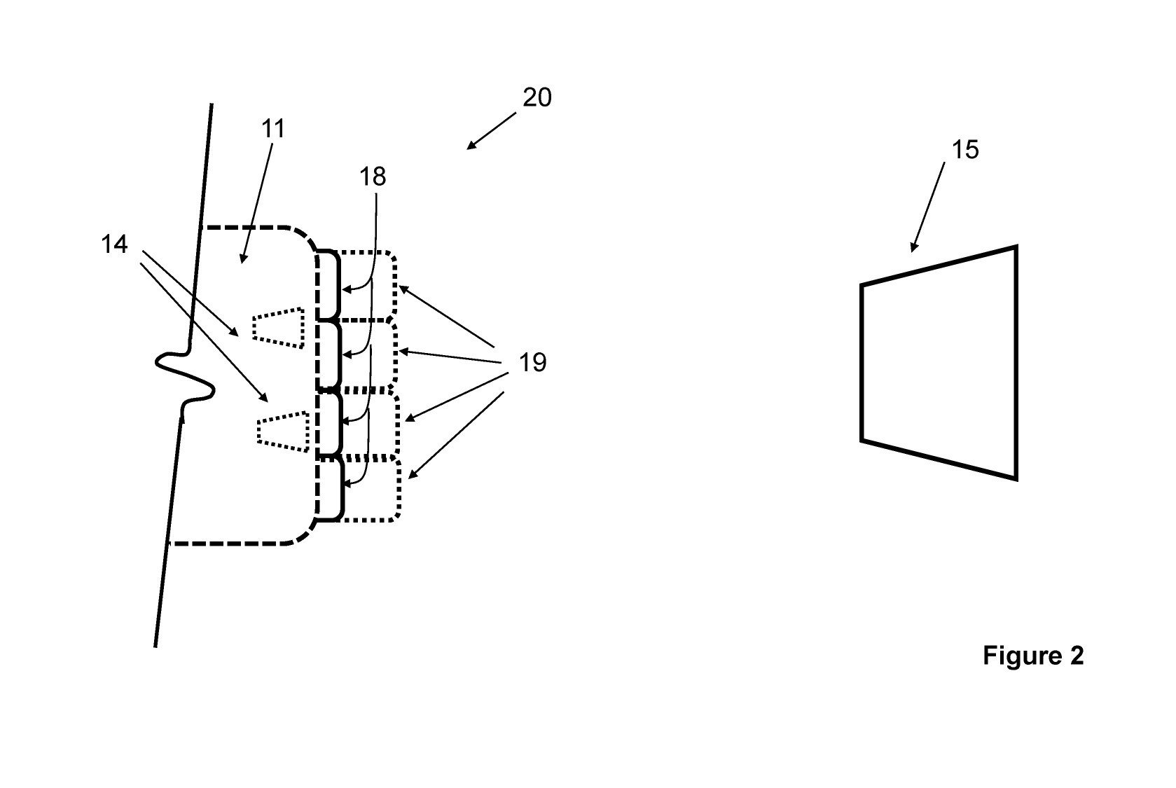

In the second embodiment 20 of the present invention shown in the schematic of FIG. 2, the bumper 12 of the embodiment 10 of FIG. 1 which is constructed and deployed as one piece, is instead constructed in several segments 18. By providing several segmented deployable bumpers, each individual segment 18 may be deployed either simultaneously or sequentially. At low speeds and if only a small object is being encountered, the bumper deploying control unit will then also have the option of deploying any one or more of the required bumper segments 18—shown in dashed lines in the schematic of FIG. 2 and indicated collectively by the numeral 19.

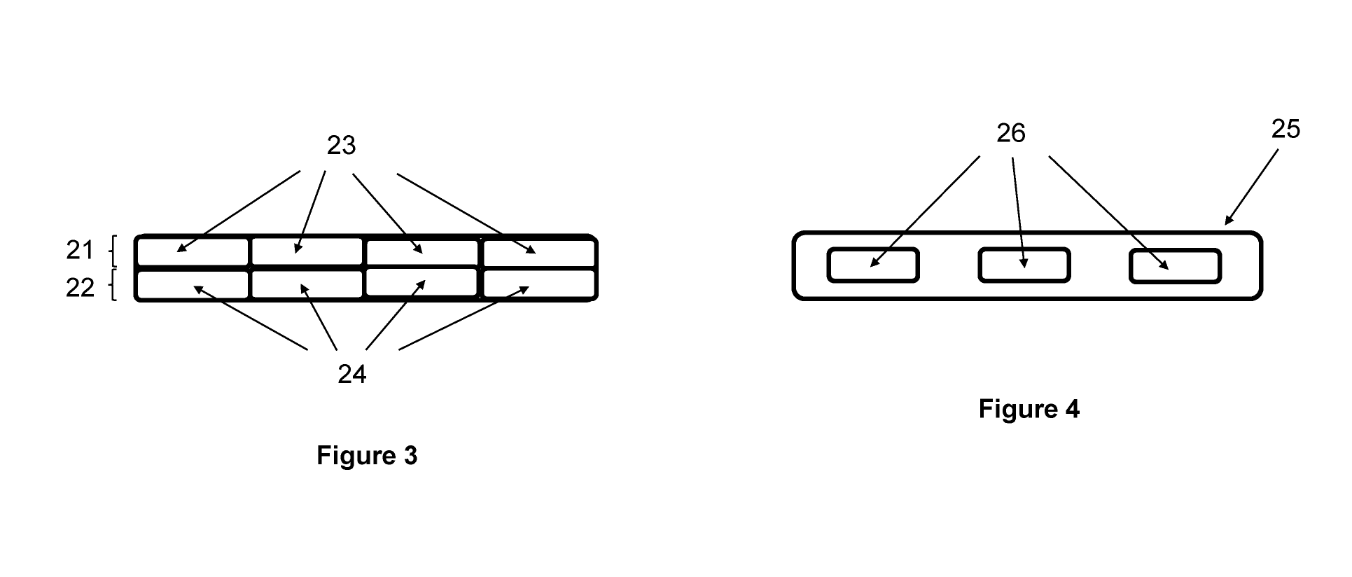

In the embodiment 20 shown in the schematic of FIG. 2, the deployable bumper 18 is shown to be constructed of several segments (four in FIG. 2) which can be independently deployed. It is, however, appreciated by those skilled in the art that the bumper may be similarly constructed with several rows of segments or in any other proper shapes and arrangements. The frontal view of one such deployable bumper that is constructed with two rows (indicated by numerals 21 and 22) of four segments (indicated by numerals 23 and 24 for the rows 21 and 22, respectively) is shown in FIG. 3. By providing several segmented deployable bumpers, each individual segment in each rows may be independently deployed to achieve maximum effectiveness. At low speeds and if only a small object is being encountered, the bumper deploying control unit will then also have the option of deploying any one or more of the required bumper segments.

In the embodiments of FIGS. 2 and 3, the deployable bumpers are shown to be constructed of several segments which can be independently deployed. In an alternative embodiment, the main body of the bumper may be fixed to the vehicle but be provided with readily replaceable and independently deployable segments such as shown in the frontal view of FIG. 4. In the frontal view of FIG. 4, the fixed bumper 25 is shown to be provided with three (preferably inserted and essentially flush) independently deployable segments 26. Such bumper systems are particularly advantageous from the repair cost point of view since they can be readily replaced following a collision.

In an alternative embodiment, the main body of the bumper shown in the frontal view of FIG. 4 may also be deployable, and be deployed when a more serious collision is predicted by the bumper deployment control unit.

The energy absorbing elements may be due to breaking or shearing of elements provided in the path of deforming bumper sections. For example, the elements 26 in FIG. 4 could be guided outward freely over ratchet-like elements that bend out of way as the bumper segment travels outward—but resist backward motion and have to be sheared to allow backward motion. During collision, the ratchet-like ends are sheared, thereby absorbing energy (in addition to other elements such as springs, dampers, deforming elements, braking elements, etc.).

Deployment may be by the release of preloaded springs only.

The release mechanism may control the speed of release (e.g., by opening/closing a damper orifice to speed up or down the rate of deployment).

The release mechanism may be assisted by charge-based gasses when very rapid deployment is detected to be needed.

In one embodiment, a motor can be provided with the means (motor or pneumatic piston that also work as shock absorbers) to retract the deployed bumper. An alternative embodiment provides a manual means of retracting the deployed bumper following deployment if there is no or minimal damage. In both cases, one option is a worm gear type and a cable that is pulled—which can be designed like a winch.

By proper sequential releasing of the deployment “springs” or the like, the bumper can be oriented towards the impacting object for maximum effectiveness.

Instead of springs, braking elements can be used so that you get a constant resisting force instead of increasing resisting force with springs. Alternatively, soft elastic/absorbing members can be used in front and in series with braking elements so that the impact force increases smoothly to the maximum braking force level. Alternatively, the braking element may be in parallel with the springs and released if the vehicle speed is not high (for stationary object—and relative approaching velocity for incoming object).

The bumper deployment and/or movement may be actively controlled by a control unit with the input from position, velocity and acceleration (relative) sensor(s).

The bumper deployment system may be equipped with sensors that measure the forces/moments/torques being applied to the bumper system. This information can in turn be used by the bumper deployment control unit to optimally plan its deployment strategy and shock and energy absorption strategy to minimize damage to the vehicle and injury to the passengers. The same information can be relayed to the vehicle control units that control the deployment of the air bag (for example to initiate one or more gas generating units to achieve optimal air bag pressure to minimize injury to the occupants—from impacting objects as well as fast moving and stiff air bag surface). They can also be used to tighten the seat belts and take other measures such as control the rate of braking, etc.

Since the velocity and acceleration of the vehicle and object in the path of collision—if it is mobile, including their relative distance, velocity and acceleration are known, the vehicle (or a dedicated control unit—computer/microprocessor) can plan and execute an optimal bumper deployment strategy to minimize, e.g., peak vehicle shock loading, minimal damage to the vehicle, maximum energy absorption, minimum passenger discomfort, etc.

The vehicle sensors can continuously measure the relative distance, velocity and acceleration of other approaching objects (such as other vehicles) even if the vehicle is not in motion and optimally deploy the bumper that be impacted. This capability provides the means of minimizing damage as a result of being rear ended while after a stop or in pile ups on fog covered roads or the like. The bumper deployment system may even be left active while the car is parked.

The disclosed deployable bumpers can also be designed for use as stationary bumpers used in different machinery, such as industrial machines such as CNCs, robotic systems, assembly lines, even for trains, etc. Such deployable bumpers are particularly useful since for the same amount of space that would be occupied by regular shock absorbing bumpers, they could provide a significantly more protection and provide an optimal shock loading profile to minimize damage and maximize energy absorption.

In one embodiment, the bumpers on cars broadcast the type of car and other characteristics such as weight, their type and their deployment state and if frontal or rear. The information may be broadcast by the bumper sensors (particularly if the sensors are RF or laser based by modulating information on their signals). Then if both colliding bumpers have the information, they could coordinate their deployment to minimize damage and impact shock, etc., to both vehicles. The information may be similarly used when a bumper is colliding other sides of the vehicle.

The sensors directly or via other sensors such as cameras can be used to estimate the size, weight, location of the bumper, its orientation and possibly the type of approaching vehicle for planning an optimal bumper deployment strategy.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for protecting an automobile, the method comprising:
detecting one or more conditions indicative of an impending collision; and
deploying one or more bumpers on the automobile for absorbing at least some energy of the collision.
